(19) United States
(12) Patent Application Publication
(10) Pub. No.: US 2024/0322592 A1
(43) Pub. Date: Sep. 26, 2024

(54) ENERGY SUPPLY STATION FOR THE ELECTRIFICATION OF CONSTRUCTION SITES AND METHOD FOR SUPPLYING A CONSTRUCTION SITE WITH ELECTRICAL ENERGY

(71) Applicant: Liebherr-Components Biberach GmbH, Biberach an der Riß (DE)

(72) Inventors: Fabian ZELL, Mittelbiberach (DE); Daniel Ried, Ingerkingen (DE)

(21) Appl. No.: 18/272,555

(22) PCT Filed: Jan. 14, 2022
(86) PCT No.: PCT/EP2022/050744

§ 371 Date: Jul. 14, 2023

(30) Foreign Application Priority Data
Jan. 15, 2021 (DE) 10 2021 100 790.9

(51) Int. Cl. H02J 7/34; H02J 7/00

(52) U.S. Cl. CPC H02J 7/34; H02J 7/0013; H02J 7/0063; H02J 7/007; H02J 2207/50; H02J 2300/30

(57) ABSTRACT

A light reactor for photochemical material production and/or treatment, including a receiving space for receiving materials to be irradiated and/or receiving a reaction vessel containing such materials, a plurality of light sources, and a plurality of optical elements, which are distributed in an annular region in a plurality of rows around the receiving space. The optical elements are designed to form light bundles having main emission axes which, from row to row, are tilted differently with respect to a longitudinal axis of the annular region and together form a radiation space constricted between two cone tips, the center of which radiation space is in the central region of the receiving space.

The present invention relates to an energy supply station for supplying consumers such as construction machines with electrical energy, comprising storage means for storing electrical energy, at least one consumer connection for charging and/or supplying a corresponding consumer such as a construction machine with electricity, at least one supply connection for connecting to an energy supply source and feeding electrical energy, as well as a power and/or energy control device for controlling the feeding and/or storing and/or releasing the electrical energy by the components, supply connection, storage means and consumer connection. The invention further relates to a method for supplying electrical energy to a construction site using such an energy supply station.

In order to be able to operate construction sites with zero local emissions, the electrification of construction machines has recently gained in importance. The increase in electrified construction machines such as excavators, caterpillars, concrete mixers, plastering machines, earth drilling machines or cranes is expected to result in a significantly higher electrical energy demand on the corresponding construction site, which cannot always be provided by an external grid connection, especially in inner-city areas, at least not so far and at least not without further expansion of the supply network.

However, the problem of satisfying a temporarily increased energy demand is not limited to inner-city construction sites, but also applies to all types of large and small construction sites and in particular to remote areas without access to energy supply, as can be the case, for example, with construction sites in non-urban areas, cable car construction, tunnel construction, new construction on a greenfield site or the construction of resettlement farms. Similarly, temporary power grid support is sometimes required for event arenas or emergency power is desired for critical infrastructure facilities such as hospitals, IT server systems, or underground/surface mining operations.

Until now, such temporary energy requirements have often been met with diesel generators, in which a diesel engine drives a generator to provide the required electrical energy. However, this eliminates local emission control and is also detrimental to the desired noise and sound level reduction.

For large construction sites or other major infrastructure measures, temporary utility buildings are therefore often erected to meet the increased energy demand, for example by laying additional supply lines or building smaller power plants, which is not very economical and is itself a difficult measure in remote regions.

It has therefore already been proposed to provide mobile energy supply stations with emission-free energy sources such as a fuel cell or with large energy storage units in the form of lithium-ion battery, which can be used to support an existing grid supply and cushion temporary peaks in demand.

For example, a container unit known as the “Big Battery Box” from the company Bredenoord is equipped with lithium ion batteries, power electronics and a battery management system in order to store electricity from photovoltaic and wind power plants and make it available for supply.

Furthermore, a mobile power plant based on fuel cells is known from the company eCap Mobility under the product name “H2PowerPack”, whereby the fuel cell is housed in a container together with lithium-ion batteries for the intermediate storage of energy, which is arranged on a trailerable chassis.

The solutions that are known so far make it difficult to meet the requirements of different consumers in the same way. The construction machines used on a construction site, for example, are regularly configured very differently from one another in terms of their energy demand, available charging times, their storage capacities and their use, so that the charging or supply tasks are also very different.

Starting from this, it is the object of the present invention to provide an improved energy supply station of the type which avoids the disadvantages of the prior art and develops the latter in an advantageous manner. In particular, the aim is to create a flexibly deployable energy supply station that can be adapted to differently configured consumers and energy supply sources of different characteristics, which can operate independently and assist in the electrification of construction sites.

The task is solved, according to the invention, with an energy supply station as claimed in claim 1, as well as a method as claimed in claim 24. Preferred embodiments of the invention are the subject-matter of the dependent claims.

Thus, it is proposed to diversify the storage means of the energy supply station so that different feed and release conditions can be equally taken into account. According to the invention, the storage means for storing electrical energy comprise differently configured storage units with different storage technologies, which are controlled and/or operated by the power and/or energy control device in dependence on the corresponding connected consumers and/or the corresponding connected energy supply sources. By using different storage technologies, the energy supply station can take into account different charging and/or supply requirements of different construction machines or other consumers and can be adapted to the respective available energy supply sources.

In an advantageous further development of the invention, the differently configured storage units can in particular comprise a fast-charge and/or fast-discharge storage unit, which can be charged and/or discharged particularly quickly, and a long-term storage unit for long-term storage of electrical energy. Such storage systems, which differ in terms of charging/discharging times and/or storage times, can on the one hand supply and/or charge consumers that require high amounts of energy in the very short term, while on the other hand the long-term storage unit can simultaneously supply consumers with lower energy demands over a longer period of time or store energy over longer time intervals.

For example, the storage units can differ from each other in their specific power density and/or their specific energy density and/or their charge/discharge times to meet different requirements.

In particular, at least one capacitor, for example in the form of a double-layer capacitor, can be provided as a storage unit in order to be able to serve high power-peaks at short notice and/or to be able to store high currents at short notice. On the other hand, in order to also be able to provide larger amounts of energy and/or store and/or release it over a longer period of time, in further development of the invention at least one accumulator and/or a battery, for example in the form of a lithium-ion accumulator and/or a lithium-ion battery, can also be provided as a storage unit. This allows higher power demands or amounts of energy to be covered over a longer period of time.

In order to be independent with regard to grid connections that may not be available locally, in further development of the invention, a fuel cell or a hydrogen/fuel cell can be provided as an energy supply source, with the aid of which, for example, a base load of the construction site or infrastructure object can be covered. The hydrogen/fuel cell may be connected or connected to the supply port.

Alternatively, or additionally, however, a supply network, for example the public supply network, can be connected via the supply connection.

Advantageously, the energy supply station has a plurality of supply connections in order to be able to connect differently configured energy supply sources, in particular a fuel cell and the supply network. Alternatively, or additionally, a plurality fuel cells or hydrogen/fuel cells can be connected simultaneously via several supply connections.

The storage means and preferably also the supply and consumer connections can advantageously be connected to power electronics or power electronic components via which the feeding and/or release of current to the respective components can be controlled. Such power electronic components may include, for example, converters such as frequency converters, current regulators such as DC/DC converters or DC/AC converters or AC/DC converters, although other power electronic components such as transistors, power MOSFETs, thyristors or IGBTs may also be provided to control the charging and/or discharging of the storage means and/or the injection and/or extraction of current via the consumers and/or supply connections.

In particular, bidirectional DC/DC controllers and/or bidirectional DC/AC controllers can be provided in order to be able to control the feeding and discharging equally or the current flow in opposite directions via the respective current controller component.

For example, a bidirectional DC/DC controller can be associated with each of the storage units, by means of which both feeding and releasing current to and from the corresponding storage unit can be controlled.

Alternatively, or additionally, such a bidirectional DC/DC controller and/or a DC/AC controller can also be associated with one of the consumer and/or supply connections in order to be able to control the current flows from and to a consumer or from and to an energy supply source.

Advantageously, the current controllers or converters can be interconnected and/or form a power electronic network between the storage means and the consumer or supply connections.

In order to be able to use the storage means intelligently and to charge or supply the consumers with energy efficiently, the power and/or energy control device may advantageously comprise energy demand determining means which determine the energy demand of the corresponding consumers connected to the energy supply station. Advantageously, the energy demand determination means are configured to determine the individual energy demand of a correspondingly connected consumer in order to be able to optimally control the amount of energy and/or power provided at the corresponding consumer connection individually for the correspondingly connected consumer. Alternatively, or additionally, the energy demand determination means can also be configured to determine the total energy demand of all consumers connected to the energy supply station.

Advantageously, it may be provided that a communication device for communicating with the consumers to be supplied is provided, preferably wireless, wherein the energy demand determining means is connected to the communication device and is adapted to determine the energy demand of the connected consumers based on the data received from the consumers via the communication device.

It can be further advantageously provided that the communication device is configured to query the operating data, in particular power and/or consumption data, of the consumers and to provide them to the energy demand determination means, which determine the energy demand of the connected consumers on the basis of the received operating data, in particular power and/or consumption data.

Depending on the determined individual and/or total energy demand of the connected consumers, the power and/or energy control device can control the operation of the different storage units, for example by controlling the associated power electronic components. For example, it can be variably defined from which storage unit which amount of energy or which power is taken and to which consumer connection which amount of energy or power is given. A particular consumer connection can receive energy from only one storage unit or can be supplied with electrical energy from differently configured storage units.

Advantageously, the storage units and/or the power electronic components are networked with each other and/or with the power and/or energy control device, in particular in such a way that information or data can be exchanged with each other and/or with the power and/or energy control device.

In further embodiments of the invention, the power and/or energy control device may include consumer identification means to identify a correspondingly connected consumer. For example, the consumer identification means may be connected to a sensor system at a corresponding consumer port, by means of which the consumer connected to the consumer connection may be identified. Alternatively, or additionally, a communication interface can also be provided, for example in the form of an RFID reader, in order to be able to identify a respective consumer by reading an RFID tag. Other identification variants, for example by reading in a marking, can also be provided.

Alternatively, or additionally, the consumer identification means can also recognize a correspondingly connected consumer on the basis of charging characteristics such as charging current or charging resistance.

Depending on the respective identified consumer, the power and/or energy control device can then control the application of current to the corresponding consumer connection from the storage means and/or from the at least one supply connection.

In an advantageous further development of the invention, the power and/or energy control device can also take into account the corresponding energy supply source connected to the at least one supply connection and/or an operating parameter of the correspondingly connected energy supply source when controlling the further components of the supply station.

Advantageously, it can be provided that the power and/or energy control device comprises a scheduling module for predictively scheduling energy demand and/or energy provision at the at least one consumer connection, the scheduling module being configured to adapt the energy demand and/or energy supply in dependence on a deployment schedule for a plurality of consumers and/or a task schedule for one or more consumers.

It can be further advantageously provided that the scheduling module is connected via a/the communication device to a construction site master computer and/or the consumers to be supplied and is configured to query the deployment schedule and/or task schedule from the construction site control computer and/or the consumers to be supplied.

Advantageously, the power and/or energy control device can comprise energy source identification means to identify the correspondingly connected energy source and/or to determine characteristic parameters thereof in order to control further components of the supply station in dependence thereon.

For example, the power and/or energy control device may be configured to use power from a supply network connected to a supply connection directly to charge and/or supply a consumer connection and, if applicable, to charge the storage means if power is left over.

On the other hand, electricity coming from a hydrogen/fuel cell can, for example, be used primarily for charging the storage means, since such a hydrogen/fuel cell can advantageously cover a lower base load and thus achieve slow charging of a storage unit. In principle, however, other control strategies adapted to the correspondingly connected energy source are also possible, wherein the power and/or energy control device can provide different control strategies for different, connected energy supply sources.

The invention is explained in more detail below on the basis of a preferred exemplary embodiment and the corresponding drawings. There are shown in the drawing:

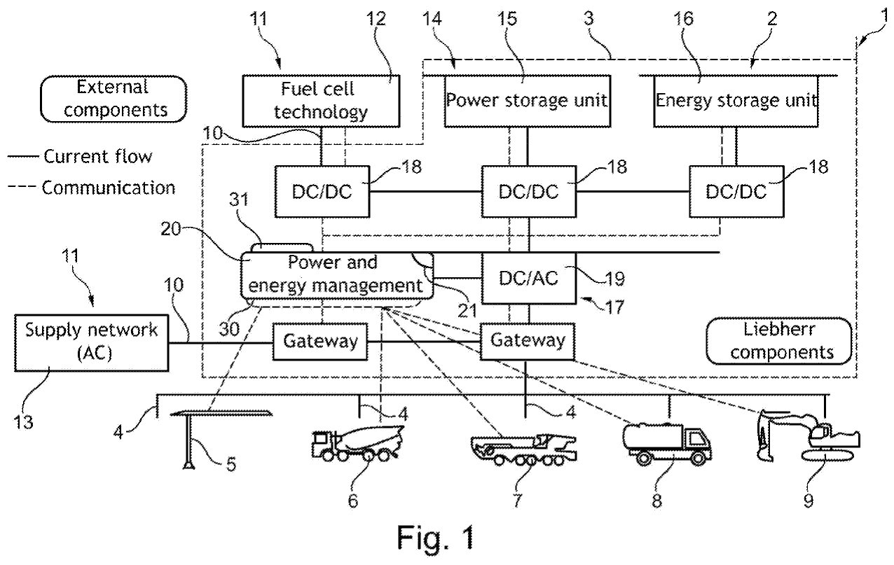

FIG. 1: the configuration of an energy supply station according to an advantageous embodiment of the invention for supplying power to a construction site and the construction machines used there.

The energy supply station 1, cf. FIG. 1, can advantageously form a mobile unit that can be moved from construction site to construction site, for example in the form of a container or a vehicle trailer. For example, the energy supply station 1 may include a housing 3 that may be mounted on the chassis of a trailer or may be transportable as a cargo item.

As FIG. 1 shows, the energy supply station 1 can have a plurality of consumer connections 4 to which different consumers, for example in the form of construction machines and/or industrial trucks, can be connected in order to be charged and/or supplied with electrical energy. For example, the energy supply station 1 may be configured to supply electrical energy to different construction machines, such as a tower crane 5, a concrete mixer 6, a mobile crane 7, a dump truck 8, or a crawler excavator 9, or to charge batteries of these construction machines, which may allow the construction machines to operate electrically in an independent manner. It is understood that, of course, other construction machines can also be connected to one of the consumer connections 4 in order to be supplied with power or to be charged.

The consumer connections 4 can thereby form charging connections in order to charge batteries or accumulators of the correspondingly connected construction machine. Alternatively, or additionally, however, the consumer connections 4 can also form operating supply connections for supplying power directly to a working construction machine during operation, for example via a sufficiently long supply cable.

As FIG. 1 further shows, the energy supply station 1 may further comprise a plurality of supply connections 10 to allow one or more energy supply sources 11 to be connected, for example a hydrogen/fuel cell 12 and/or a supply network 13, which may for example be a part of the public power grid.

Accordingly, the supply connections 10 may form a network connection and/or an energy cell connection.

The consumer connections 4 and/or the supply connections 13 can advantageously be arranged to be accessible from an outside of the energy supply station 1 and/or be configured as detachable connection connections, for example in the form of plug-in connections, in order to be able to detachably connect a corresponding consumer 5, 6, 7, 8, 9 or a corresponding energy source 11 in a simple manner.

In order to be able to store the energy coming from the energy sources 11, the energy supply station 1 comprises storage means 14 which can be received or accommodated in the housing 3.

The storage means 14 thereby advantageously comprise differently configured storage units 15, which may have different storage characteristics and use different storage technologies. In particular, the storage means 14 may comprise a power storage unit 15 on the one hand and an energy storage unit 16 on the other hand. The power storage unit 15 can temporarily store and release very high amounts of power, while the energy storage unit can preferably store high amounts of energy for longer periods of time.

For example, a capacitor that can be charged and discharged quickly can be provided as the power storage unit 15, for example in the form of a double-layer capacitor, in order to cover short-term power-peaks and, if necessary, to be able to store high amounts of energy occurring at short notice. Such short-term backflowing, larger amounts of energy can occur, for example, when one of the connected construction machines is supplied with energy from the energy supply station 1 during operation, for example, via a supply cable, and is supplied, so to speak, from the energy supply station during network operation.

The energy storage unit 16, on the other hand, may be in the form of a battery or accumulator, such as a lithium-ion battery or other form of battery capable of storing high amounts of energy for extended periods of time. Such a battery as energy storage unit 16 can cover a larger energy demand over a longer period of time.

While the power storage unit 15 may be characterized by a very high specific power density, which may exceed that of a battery by one or more powers of ten, for example, the energy storage unit 11 may be characterized by a very high specific energy density, which may exceed that of the power storage unit 15 by one or more powers of ten.

To supply and discharging current from the storage means 14 and to supply current to the consumer connections 4, the energy supply station 11 comprises power electronics 17, which may comprise several power electronic components such as current converters, current controllers, switching elements or other components such as IGPTs, thyristors or transistors.

In particular, the power electronics 17 may include DC/DC converters or DC/DC controllers that can be used to control the flow of current into or out of the storage means. For example, in the case of a double-layer capacitor, the voltage changes depending on the filling state, which the DC/DC controller can take into account when storing or drawing current. Such DC/DC converters or DC/DC controllers denote an electrical circuit capable of converting a DC voltage supplied at the input into a DC voltage with a higher, lower or inverted voltage level and capable of transferring energy from the high voltage level to the low voltage level, for example in order to charge the respective storage unit, and also transferring it in the other direction, i. e. storing it out or transferring it from the storage unit to the DC voltage circuit of the consumer system.

The DC/DC controllers 18 are advantageously configured to operate bidirectionally in order to be able to control both the storage and the drawing of current into and out of the corresponding storage element.

As FIG. 1 shows, each of the storage units 15, 16 can have such a DC/DC controller 18 associated with it or upstream of it. Such a DC/DC controller 18 can also be associated with or connected upstream of the supply connection 10 to which the hydrogen/fuel cell 12 is connected, cf. FIG. 1.

Further, the system may also include a DG/AC actuator 19 that may be upstream of the consumer connections 4 and/or may be upstream of the supply connection 10 to which the supply network 13 is connected. Such a DG/AC converter refers to an electrical circuit that can convert a DC voltage supplied at the input to an AC voltage with a higher, lower, equal or inverted voltage level and is capable of transferring energy from the high voltage level to the low voltage level. Advantageously, this DC/AC controller can also be configured to operate bidirectionally in order to be able to convert an AC voltage into a DC voltage in the manner.

As FIG. 1 shows, the components of the energy supply station 1 are controlled and/or regulated by a higher-level power and/or energy control device 20, the power and/or energy control device 20 being configured in particular to control the feeding and discharging of power to and from the storage units 15 and 16 and/or to control the application of power to the consumer connections 4 from the storage means 14 and/or from one of the supply connections 10 and/or to control the feeding of power from the supply connections 10.

As FIG. 1 shows, the power and/or energy control device 19 may be communicatively connected to the power electronics components, in particular the DC/DC controllers 18 and DC/AC controllers 19, to transmit actuating commands and/or receive feedback. Alternatively, or additionally, the power and/or energy control device 20 is also communicatively connected to the storage means 14 and/or communicatively connected to the energy source 11 connected to the respective supply connection 10 to be able to transmit control commands and/or receive feedback.

The power and/or energy control device 20 may include a data processing device comprising, for example, a microprocessor, a program memory, and a working memory to process corresponding signals and execute control routines.

In particular, the power and/or energy control device 20 may comprise energy demand determining means 21 to be able to determine the individual energy demand of the respective consumer connected to a consumer connection 4, in order to then control the application of energy to the respective consumer connection 4 in terms of power and/or amounts of energy in dependence on the respective individually determined energy demand.

For this purpose, the control device 20 can determine which of the storage units 15 and 16 respectively provides how much power and/or energy or is provided at the corresponding consumer connection 10. For this purpose, the control device 20 can control the previously explained components of the energy supply station 1 in a corresponding manner.

Advantageously, the energy supply station 1 features intelligent control strategies as well as efficient energy management.

The energy and power control system 20 handles the communication of receiving data from different (a plurality of/a single) construction machine/machines 5-9, processing it, and providing corresponding energy to charge the construction machines 5-9 as needed. Communication can be wireless or via a direct connection.

The energy and power control 20 takes over the task of a predictive planning of energy provision for the different construction machines 5-9 and coordinates the efficient energy flow between storage medium and construction machine 5-9 for the optimized loading process with regard to different parameters (e.g., service life and costs) of the storage media.

The energy and power control system 20 has the intelligence to automatically detect which construction machine 5-9 requires how much energy at what time, and handles the scheduling and coordination of the different storage media for providing the energy and charging the construction machines 5-9.

The energy and power control system 20 optimizes the power flows based on predicted work processes of the construction machines 5-9 with regard to power consumption via the supply connection and the storage states of the different storage units.

The energy and power control system 20 has a permanent (wireless) communication to the different construction machines 5-9 for detecting the corresponding loading states. The energy and power control system has an external interface for retrieving different data for the planned work processes. Based on this data, the energy and power control system coordinate the energy flows and the provision of energy for charging the different construction machines 5-9 and ensures energetically optimized operation.

1. An energy supply station for supplying consumers with electrical energy comprising;
storage means for storing electrical energy comprising two or more storage units, wherein at least two of the storage units are differently configured storage units having different storage technologies one from one another;
at least one consumer connection for charging and/or supplying a corresponding connected consumer with power;
at least one supply connection for connecting to an energy supply source and feeding electrical energy; and
a power and/or energy control device for controlling one or more of the feeding, storing, or releasing the electrical energy;
wherein the power and/or energy control device is configured to control the differently configured storage units individually in dependence on one or more of the connected consumers and/or on one or more of the connected energy supply sources.

2. The energy supply station according to claim 1, wherein two of the differently configured storage units comprise a power storage unit with a high power density on the one hand and an energy storage unit with a high energy density.

3. The energy supply station according to claim 1, wherein two of the differently configured storage units comprise a fast-charge and/or fast-discharge storage unit for fast storage and/or discharge of high currents and a long-term storage unit for long-term storage of high amounts of energy.

4. The energy supply station according to claim 1, wherein the storage means comprise;
a capacitor for covering high power-peaks; and
a battery for long-term storage of high amounts of energy.

5. The energy supply station according to claim 1 further comprising power electronics comprising current controllers in the form of DC/DC and DC/AC controllers provided between two of the storage units and one or more of the consumers and/or one or more of the supply connections.

6. The energy supply station according to claim 1, wherein two of the differently configured storage units are each associated with a bidirectionally configured DC/DC controller for controlling the feeding and discharging current.

7. The energy supply station according to claim 1, wherein at least one of the supply connections is associated with a DC/DC controller for controlling the current flow at the supply connection to which a hydrogen/fuel cell is connected.

8. The energy supply station according to claim 1, wherein a plurality of supply connections are provided to which differently configured energy supply sources are connected.

9. The energy supply station according to claim 1 further comprising at least one hydrogen/fuel cell connected to the at least one supply connection.

10. The energy supply station according to claim 1 further comprising at least one supply network connected to the at least one supply connection.

11. The energy supply station according to claim 10, wherein each connected supply connection is further connectable to the at least one consumer connection past the storage means.

12. The energy supply station according to claim 1, wherein the power and/or energy control device comprises energy demand determining means for determining the energy demand of the consumers connected to the at least one consumer connection.

13. The energy supply station according to claim 12, wherein the energy demand determining means is configured;
to individually determine the energy demand of a plurality of consumers connected to a plurality of consumer connections, respectively; and
to control the application of electrical power and/or energy to the plurality of consumer connections in dependence on the individually determined energy demand.

14. The energy supply station according to claim 1 further comprising a communication device for communicating with the consumers to be supplied;
wherein the energy demand determining means is connected to the communication device and is further configured to determine the energy demand of the connected consumers based on data received from the consumers via the communication device.

15. The energy supply station according to claim 14, wherein the communication device is further configured to query operating data of the consumers and to provide the data to the energy demand determination means, which determine the energy demand of the connected consumers on the basis of the received operating data.

16. The energy supply station according to claim 1, wherein the power and/or energy control device comprises consumer identification means for identifying a corresponding consumer connected to the at least one consumer connection and is configured to variably control at least one of the power electronics, the supply connection, the storage means or the consumer connection in dependence on the identified consumers.

17. The energy supply station according to claim 16, wherein the consumer identification means comprise a sensor system at the at least one consumer connection.

18. The energy supply station according to claim 1, wherein the power and/or energy control device comprises energy source identification means for identifying the corresponding energy source connected to the at least one supply connection.

19. The energy supply station according to claim 1, wherein the power and/or energy control device is configured to control the application of power from the storage means to the at least one consumer connection and from the at least one supply connection in dependence on the connected consumer sources and the connected energy sources.

20. The energy supply station according to claim 1, wherein the power and/or energy control device comprises a scheduling module for predictively scheduling energy demand and/or energy provision at the at least one consumer connection, the scheduling module being configured to adapt energy demand and/or energy supply in dependence on a deployment schedule for different consumers and/or a task schedule for one or more consumers.

21. The energy supply station according to claim 20, wherein the scheduling module is connected via a communication device to a construction site master computer and/or to the consumers to be supplied and is configured to query the deployment schedule and/or task schedule from the construction site master computer and/or the consumers to be supplied.

22. The energy supply station according to claim 1, wherein the energy supply station is configured as a mobile unit.

23. The energy supply station according to claim 1, wherein the energy supply station is configured to operate emission-free and independently.

24. A method for supplying a construction site with electrical energy using the energy supply station according to claim 1, wherein various consumers are successively and/or simultaneously connected to the consumer connections of the energy supply station and are charged with electrical energy for operation and/or supplied with electrical energy during operation by the energy supply station.
